(19) United States
(12) Patent Application Publication
(10) Pub. No.: US 2023/0196443 A1
(43) Pub. Date: Jun. 22, 2023

(54) CONTROLLER, PRODUCT TRADING SYSTEM, AND AUTOMATED ORDERING PROGRAM

(71) Applicants: Kristopher Andrew TATE, Kyoto-shi, Kyoto (JP); connectFree Corporation, Kyoto-shi, Kyoto (JP)

(72) Inventor: Kristopher Andrew TATE, Kyoto-shi, Kyoto (JP)

(73) Assignees: Kristopher Andrew Tate, Kyoto-shi, Kyoto (JP); connectFree Corporation, Kyoto-shi, Kyoto (JP)

(21) Appl. No.: 17/910,743

(22) PCT Filed: Mar. 11, 2021
(86) PCT No.: PCT/JP2021/009774

§ 371 Date: Feb. 27, 2023

(30) Foreign Application Priority Data
Mar. 11, 2020 (JP) 2020-041761

(51) Int. Cl. G06Q 30/0601; G06Q 10/083

(52) U.S. Cl. CPC G06Q 30/0635; G06Q 10/083

(57) ABSTRACT

A platform enables automated trading according to the situation. A controller includes: a state information acquisition unit that acquires information related to a consumption state of a product from a target consuming the product; and a request generation unit that, when determining that a predetermined condition is satisfied on the basis of the acquired information, generates a purchase request for purchasing the product and transmits the purchase request to an outside. The purchase request includes information specifying a product desired to be purchased.

### TECHNICAL FIELD

The present disclosure relates to a controller, a product trading system, and an automated ordering program that can achieve electronic product trading.

### BACKGROUND ART

In a distribution system according to the related art, products are delivered from producers to purchasers through retailers. For this distribution system, for example, JP 2019-128814 A (Patent Document 1) discloses an electronic trading system that can activate a market.

### CITATION LIST

### Patent Document

Patent Document 1: JP 2019-128814 A

### DISCLOSURE OF THE INVENTION

### Problem to be Solved by the Invention

The electronic trading system disclosed in Patent Document 1 supports product trading between purchasers and sellers. The electronic trading system according to the related art is just for electronic trading between the purchasers and the sellers, and the start of trading is determined by human judgment.

An object of the present disclosure is to provide a platform that enables automated trading according to the situation.

### Means for Solving Problem

According to an aspect of the present disclosure, there is provided a controller including: a state information acquisition unit that acquires information related to a consumption state of a product from a target consuming the product; and a request generation unit that, when determining that a predetermined condition is satisfied on the basis of the acquired information, generates a purchase request for purchasing the product and transmits the purchase request to an outside. The purchase request includes information specifying a product desired to be purchased.

The request generation unit may include at least one of the number of products desired to be purchased and a desired price when the product is purchased.

The request generation unit may include a delivery deadline determined on the basis of the acquired information.

The state information acquisition unit may include a sensing unit that senses a remaining amount of the product.

The state information acquisition unit may include an interface that acquires information managed by the target consuming the product.

The request generation unit may attach an electronic signature to the purchase request and transmit the purchase request to the outside.

The request generation unit may include positional information of the controller in the purchase request and transmit the purchase request to the outside.

The controller may further include a communication unit that performs data communication with a transmission destination of the purchase request using an authenticated IP address.

According to another aspect of the present disclosure, there is provided a product trading system including: the above-described controller; a second request generation unit that generates a sales request for selling a product and transmits the sales request to an outside; and a matching processing unit that determines a set of the purchase request and the sales request whose contents are matched with each other.

According to yet another aspect of the present disclosure, there is provided an automated ordering program that is executed by a computer and causes the computer to execute: a step of acquiring information related to a consumption state of a product from a target consuming the product; a step of determining whether a predetermined condition is satisfied on the basis of the acquired information; and a step of generating a purchase request for purchasing the product and transmitting the purchase request to an outside when it is determined that the predetermined condition is satisfied. The purchase request includes information specifying a product desired to be purchased.

### Effect of the Invention

According to the present disclosure, it is possible to achieve a platform that enables automated trading according to the situation.

### BRIEF DESCRIPTION OF DRAWINGS

FIG. 1 is a diagram illustrating an overview of a process in a product trading system according to an embodiment;

FIG. 2 is a schematic diagram illustrating an example of a configuration of a consumption entity constituting the product trading system according to this embodiment;

FIG. 3 is a schematic diagram illustrating an example of a configuration of a supplier terminal used by a supplier constituting the product trading system according to this embodiment;

FIG. 4 is a schematic diagram illustrating an example of a configuration of an operation server constituting the product trading system according to this embodiment;

FIG. 5 is a flowchart illustrating a processing procedure of an automated ordering function of the product trading system according to this embodiment;

FIG. 6 is a schematic diagram illustrating an example of a configuration in which a controller of the product trading system according to this embodiment acquires a state value;

FIG. 7 is a schematic diagram illustrating another example of the configuration in which the controller of the product trading system according to this embodiment acquires the state value;

FIG. 8 is a schematic diagram illustrating an example of a purchase request generated by the controller of the product trading system according to this embodiment;

FIG. 9 is a schematic diagram illustrating an example of a user interface screen provided by the supplier terminal of the product trading system according to this embodiment;

FIG. 10 is a diagram illustrating an example of user management by the operation server of the product trading system according to this embodiment;

FIG. 11 is a flowchart illustrating a processing procedure of a matching process in the operation server of the product trading system according to this embodiment;

FIG. 12 is a flowchart illustrating the processing procedure of the matching process in the operation server of the product trading system according to this embodiment;

FIG. 13 is a diagram illustrating an example of delivery charge definition used in the product trading system according to this embodiment;

FIG. 14 is a diagram illustrating another example of the delivery charge definition used in the product trading system according to this embodiment;

FIG. 15 is a diagram illustrating an outline of a process in another product trading system according to this embodiment; and

FIG. 16 is a diagram illustrating an outline of a process in yet another product trading system according to this embodiment.

### MODE(S) FOR CARRYING OUT THE INVENTION

An embodiment of the present disclosure will be described in detail with reference to the drawings. In addition, the same or equivalent portions in the drawings are denoted by the same reference numerals, and the description thereof will not be repeated.

### A. PRODUCT TRADING SYSTEM

First, a product trading system 1 according to this embodiment will be described. The product trading system 1 provides a platform that enables trading corresponding to a product purchase request from any consumption entity.

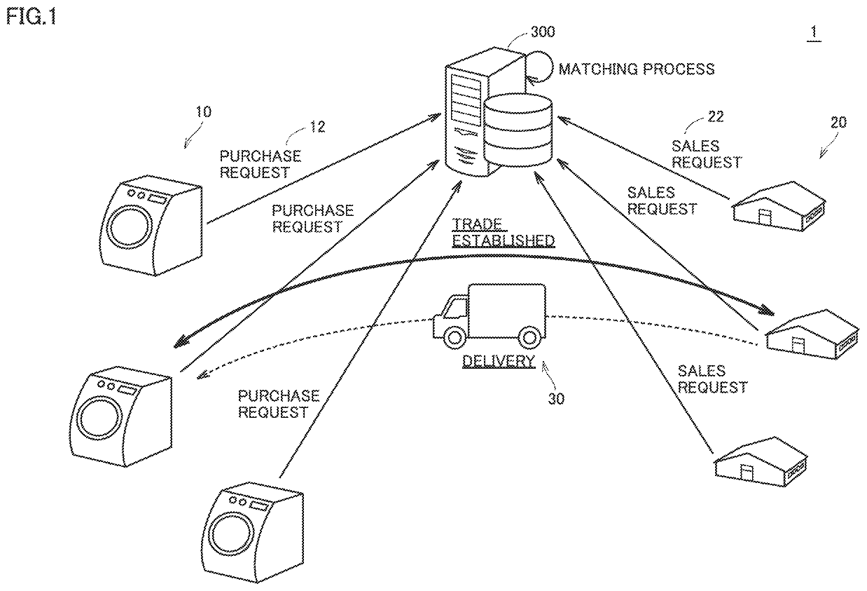

FIG. 1 is a diagram illustrating an outline of a process in the product trading system 1 according to this embodiment. Referring to FIG. 1, the product trading system 1 includes one or more consumption entities 10 that consume one or more products, one or more suppliers 20 that provide at least some of the one or more products, and an operation server 300 that can be accessed by any of the one or more consumption entities 10 and the one or more suppliers 20.

The products handled in the product trading system 1 are not particularly limited. However, products expected to be purchased repeatedly, such as daily necessities and consumables, are suitable.

In this specification, the “consumption entity 10” includes any entity (subject) that consumes any product, typically, natural persons, such as individuals who are expected to consume the products, non-natural persons (including organizations and corporations), such as stores and offices, computers, and devices having a computing function. The “consumer entity 10” is a concept including any entity (subject) that can make some decisions about the trading of the product.

In this specification, the “supplier 20” includes an entity (subject) that provides any product. Typically, the producer or importer of the product is assumed as the “supplier 20”. The “supplier 20” may be a logistics company that stores or manages any product or may be a computer or a device having a computing function. The “supplier 20” is a concept including any entity (subject) that can make some kind of decision about the trading of the product, like the “consumption entity 10”.

In the following description, an example in which the consumption entity 10 is a computer or a device having a computing function will be mainly described. FIG. 1 illustrates, for example, a configuration in which a detergent, a fabric softener, or the like is automatically ordered from a washing machine according to the situation, without responding to a user's operation or the like.

Each of the consumption entities 10 transmits, to the operation server 300, a purchase request 12 including information for specifying any product desired to be purchased and the number of products when predetermined conditions (including both objective conditions and subjective conditions) are satisfied. In addition, the purchase request 12 may include a desired purchase price.

Meanwhile, each of the suppliers 20 transmits, to the operation server 300, a sales request 22 including information for specifying any product that the supplier 20 wants to sell and the number of products that can be provided. In addition, the sales request 22 may include a desired sales price.

The operation server 300 compares the purchase requests 12 from one or more consumption entities 10 and the sales requests 22 from one or more suppliers 20 and determines whether the content of the purchase request 12 and the content of the sales request 22 are matched with each other (hereinafter, also referred to as a “matching process”). That is, the operation server 300 has a matching processing function of determining a set of the purchase request 12 and the sales request 22 whose contents are matched with each other. When the purchase request 12 and the sale request 22 are matched with each other, it is determined that a trade has been established.

The operation server 300 notifies the supplier 20 corresponding to the sales request 22, for which the trade has been established, that the trade has been established and delivers the product as a trading target to the consumption entity 10. In addition, the product may be delivered by the supplier 20 or typically by any deliverer 30.

The operation server 300 is also in charge of a payment process between the consumption entity 10 and the supplier 20, which will be described below.

Hereinafter, the configuration, functions, and process of the product trading system 1 according to this embodiment will be described in detail.

### B. HARDWARE CONFIGURATION>

Next, an example of a hardware configuration of the product trading system 1 according to this embodiment will be described.

(b1: Consumption Entity 10)

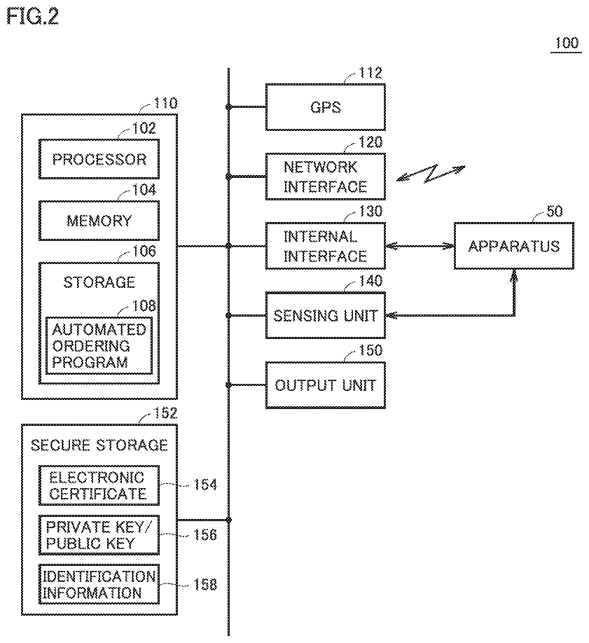

FIG. 2 is a schematic diagram illustrating an example of the configuration of the consumption entity 10 constituting the product trading system 1 according to this embodiment. The consumption entity 10 may be implemented by a controller 100, which is a type of computer, as a main component.

Referring to FIG. 2, the controller 100 includes a control unit 110 which is a processing circuitry as a main component. The control unit 110 is a computation entity for implementing the provision of functions and the executions of processes according to this embodiment.

The control unit 110 may be configured using a processor and a memory illustrated in FIG. 2 such that the processor executes computer readable instructions stored in the memory. Alternatively, the control unit 110 may be implemented using a hard-wired circuit such as an application specific integrated circuit (ASIC) in which a circuit corresponding to the computer readable instructions is incorporated. Alternatively, the control unit 110 may be implemented by implementing a circuit corresponding to the computer readable instructions on a field-programmable gate array (FPGA). In addition, the control unit 110 may be implemented by appropriately combining the processor, the memory, the ASIC, the FPGA, and the like.

In the configuration using the processor and the memory illustrated in FIG. 2, the control unit 110 includes a processor 102, a main memory 104, and a storage 106.

The processor 102 is an arithmetic circuit that sequentially reads and executes the computer readable instructions. The processor 102 is composed of, for example, a central processing unit (CPU), a micro processing unit (MPU), a graphics processing unit (GPU), or the like. The control unit 110 may be implemented using a plurality of processors 102 (multiprocessor configuration) or may be implemented using a processor having a plurality of cores (multicore configuration).

The main memory 104 is a volatile storage device such as a dynamic random access memory (DRAM) or a static random access memory (SRAM). The processor 102 deploys a designated program among various programs stored in the storage 106 onto the main memory 104 and cooperates with the main memory 104 to implement various processes according to this embodiment.

The storage 106 is, for example, a non-volatile storage device such as a hard disk drive (HDD), a solid state drive (SDD), or a flash memory. The storage 106 stores various programs executed by the processor 102 and various kinds of data. Typically, the storage 106 stores an automated ordering program 108 for implementing an automated ordering function which will be described below.

In the configuration illustrated in FIG. 2 in which the processor 102 executes the computer readable instructions stored in the memory, the memory corresponds to the storage 106.

The controller 100 further includes a global positioning system (GPS) 112, a network interface 120, an internal interface 130, a sensing unit 140, and an output unit 150.

The GPS 112 acquires positional information of the controller 100. In addition, any global navigation satellite system (GNSS) can be adopted as the GPS 112.

The network interface 120 performs data communication with the operation server 300 through a network. The network interface 120 may be a wired or wireless network interface. In a case in which the network interface 120 is a wired network interface, the network interface 120 may include wired connection terminals such as an Ethernet (registered trademark) port, a universal serial bus (USB) port, a serial port, such as IEEE1394, and a legacy parallel port. In addition, in a case in which the network interface 120 is a wireless network interface, the network interface 120 may include a processing circuitry and an antenna for wireless communication with devices, routers, mobile base stations, and the like. For example, wireless communication corresponding to the network interface 120 may be any one of Wi-Fi (registered trademark), Bluetooth (registered trademark), ZigBee (registered trademark), Low Power Wide Area (LPWA), GSM (registered trademark), W-CDMA, CDMA2000, Long Term Evolution (LTE), and the fifth-generation mobile communication system (5G).

The internal interface 130 and the sensing unit 140 correspond to a state information acquisition unit that acquires information related to the consumption state of the product from a target (an apparatus 50 in this case) that consumes the product. Here, the “information related to the consumption state of the product” is a concept including information necessary for determining whether or not to order a target product. Typically, the “information related to the consumption status of the product” includes any information related to the consumption of the product, such as the number or amount of products remaining in the target, the total consumption amount or consumption rate of the product in the target, the history of adding or consuming the product in the target, and a change in the addition or consumption of the product in the target over time.

For example, the internal interface 130 performs data communication with the apparatus 50 such as a washing machine. The internal interface 130 can acquire a necessary state value from a control logic mounted in the apparatus 50. Typically, the internal interface 130 acquires information (for example, inventory information, operation history information, and the like) managed by the target that consumes the product.

The sensing unit 140 senses necessary information from the apparatus 50, such as a washing machine, or a portion related to the apparatus 50. Any sensor can be used as the sensing unit 140. Typically, the sensing unit 140 may be configured to sense the remaining amount of product.

The output unit 150 is a component for presenting the processing result of the control unit 110 to the outside. For example, the output unit 150 may be a liquid crystal display (LCD), an organic electro-luminescence (EL) display, or the like. In addition, the output unit 150 may be, for example, any indicator or speaker.

The controller 100 may further include a secure storage 152. The secure storage 152 is a storage unit that stores information necessary for implementing a secure process. The secure storage 152 may be a non-volatile storage device, such as a hard disk drive, an SSD, or a flash memory, like the storage 106. In this case, a known access restriction function may be added to prevent a change of the stored data. In addition, a security chip, such as a trusted platform module (TPM), may be used. Furthermore, necessary information may be stored using a radio frequency identifier (RFID) tag or the like.

The secure storage 152 stores, for example, an electronic certificate 154, a key pair 156 that is composed of a private key and a public key, and identification information 158. The electronic certificate 154 is issued by any issuer (typically, a certificate authority). For example, the key pair 156 is used for a process of adding an electronic signature to information output from the controller 100 in order to prevent the falsification or spoofing of information. The identification information 158 includes information (for example, a serial number, a manufacturing number, or the like) for uniquely identifying the controller 100.

For example, the controller 100 attaches an electronic signature generated using its own private key to the purchase request 12 to be transmitted to the operation server 300 such that the operation server 300 and the supplier terminal 200 can authenticate that the purchase request 12 is legitimate. In this way, the controller 100 may add the electronic signature to the generated purchase request 12 and transmit the purchase request 12 to the outside.

In addition, the electronic signature generated using the private key of the controller 100 may be added to a data set including the identification information 158 of the controller to the purchase request 12. In this case, it is possible to more reliably authenticate the validity of the request source of the purchase request 12.

(b2: Supplier 20)

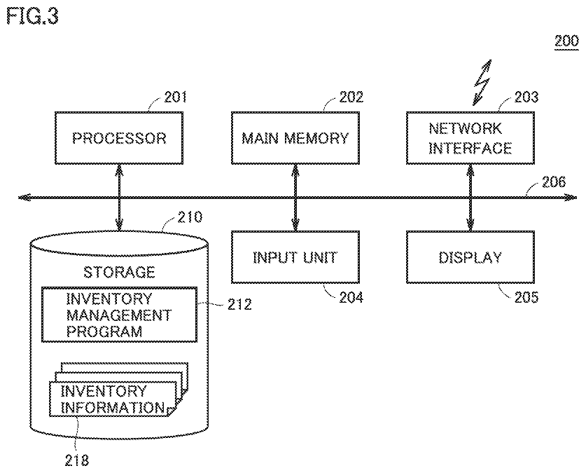

FIG. 3 is a schematic diagram illustrating an example of a configuration of the supplier terminal 200 that is used in the supplier 20 constituting the product trading system 1 according to this embodiment. Typically, the supplier terminal 200 is implemented using a general-purpose computer.

Referring to FIG. 3, the supplier terminal 200 includes one or more processors 201, a main memory 202, a network interface 203, an input unit 204, a display 205, and a storage 210 as main components. These components are connected to each other through an internal bus 206.

The processor 201 is composed of, for example, a CPU, a GPU, or the like. A plurality of processors 201 may be disposed, or a processor 201 having a plurality of cores may be adopted.

The main memory 202 is composed of a volatile storage device such as a DRAM or a SRAM. The storage 210 is composed of a non-volatile storage device, such as a hard disk drive or an SSD, and stores various programs executed by the processor 201 and various kinds of data. Among the programs stored in the storage 210, a designated program code is deployed onto the main memory 202, and the processor 201 sequentially executes computer readable instructions included in the program code deployed onto the main memory 202 to implement various functions which will be described below.

Typically, the storage 210 stores an inventory management program 212 for managing an inventory of suppliable products and inventory information 218 indicating the state of each product to be subjected to inventory management.

The network interface 203 performs data communication with the operation server 300 through the network. The network interface 203 may include, for example, an Ethernet (registered trademark) port such that communication can be performed through the Internet.

The input unit 204 receives any input instruction. The display 205 displays, for example, the processing result of the processor 201.

All or a portion of the supplier terminal 200 may be implemented using a hard-wired circuit such as an ASIC into which a circuit corresponding to the computer readable instructions is incorporated. Alternatively, the supplier terminal 200 may be implemented using the circuit corresponding to the computer readable instructions on an FPGA. In addition, the supplier terminal 200 may be implemented by appropriately combining the processor 201, the main memory, the ASIC, the FPGA, and the like.

The supplier terminal 200 may further have a component for reading, from a non-transitory medium which stores the inventory management program 212 composed of computer readable instructions, the stored program and the like. The medium may be, for example, an optical medium, such as a digital versatile disc (DVD), a semiconductor medium, such as a USB memory, or the like. The inventory management program 212 may not only be installed in the supplier terminal 200 through the medium, but may also be provided from a distribution server on the network.

(b3: Operation Server 300)

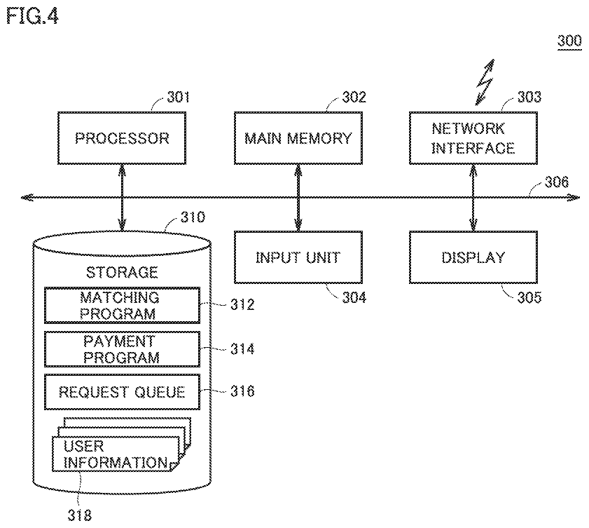

FIG. 4 is a schematic diagram illustrating an example of a configuration of the operation server 300 constituting the product trading system 1 according to this embodiment. Typically, the operation server 300 is implemented using one or more general-purpose computers.

Referring to FIG. 4, the operation server 300 includes one or more processors 301, a main memory 302, a network interface 303, an input unit 304, a display 305, and a storage 310 as main components. These components are connected to each other through an internal bus 306.

The processor 301 is composed of, for example, a CPU, a graphics processing unit (GPU), or the like. A plurality of processors 301 may be disposed, or a processor 301 having a plurality of cores may be adopted.

The main memory 302 is a volatile storage device such as a dynamic random access memory (DRAM) or a static random access memory (SRAM). The storage 310 is composed of a non-volatile storage device, such as a hard disk drive or a solid state drive (SSD), and stores various programs executed by the processor 301 and various kinds of data. Among the programs stored in the storage 310, a designated program code is deployed onto the main memory 302, and the processor 301 sequentially executes computer readable instructions included in the program code deployed onto the main memory 302 to implement various functions which will be described below.

Typically, the storage 310 stores a matching program 312 for implementing a matching process, a payment program 314 for implementing a payment process, a request queue 316, and user information 318 including various kinds of information related to the consumption entity 10 and the supplier 20. The request queue 316 temporarily stores one or more purchase requests 12 from one or more consumption entities 10 and one or more sales requests 22 from one or more suppliers 20.

The matching program 312 and the payment program 314 correspond to a product trading program that causes a computer to perform product trading between the consumption entity 10 and the supplier 20.

The network interface 303 is in charge of data exchange with, for example, the consumption entity 10 and the terminal of the supplier 20. For example, the network interface 303 may include an Ethernet port such that communication can be performed through the Internet.

The input unit 304 receives any input instruction. The display 305 displays, for example, the processing result of the processor 301.

All or a portion of the operation server 300 may be implemented using a hard-wired circuit such as an ASIC into which a circuit corresponding to the computer readable instructions is incorporated. Alternatively, the operation server 300 may be implemented using the circuit corresponding to the computer readable instructions on an FPGA. In addition, the operation server 300 may be implemented by appropriately combining the processor 301, the main memory, the ASIC, the FPGA, and the like.

The operation server 300 may further have a component for reading, from a non-transitory medium which stores the matching program 312 and the payment program 314 composed of computer readable instructions, the stored programs and the like. The medium may be, for example, an optical medium, such as a DVD, a semiconductor medium, such as a USB memory, or the like.

The matching program 312 and the payment program 314 may not only be installed in the operation server 300 through the medium, but may also be provided from the distribution server on the network.

### C. CONSUMPTION ENTITY 10 AND CONTROLLER 100

In the product trading system 1 according to this embodiment, the consumption entity 10 has a function (hereinafter, also referred to as an “automated ordering function”) that can automatically order a necessary product as needed.

The consumption entity 10 monitors the state of the apparatus 50, such as a washing machine, and automatically orders a product corresponding to predetermined conditions when the state of the apparatus 50 satisfies the predetermined conditions (that is, generates and transmits the purchase request 12).

In the following description, a washing machine is given as a typical example of the apparatus 50. However, the apparatus 50 is not limited thereto and can be any apparatus. Examples of home appliances include copiers, multifunction machines, printers (products: toner, ink, paper, and the like), vacuum cleaners (products: paper packs), shavers with a cleaning function (products: cleaning liquids), coffee makers (product: coffee), refrigerators (products: beverages, food, and the like), air conditioners (products: filters), and lighting fixtures (products: fluorescent lamps, LED bulbs, and the like).

(c1: Processing Procedure)

First, a processing procedure of the automated ordering function of the product trading system 1 according to this embodiment will be described.

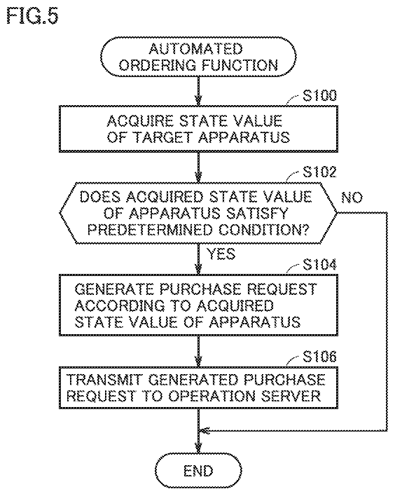

FIG. 5 is a flowchart illustrating the processing procedure of the automated ordering function of the product trading system 1 according to this embodiment. Each step illustrated in FIG. 5 is implemented by the execution of the automated ordering program 108 by the processor 102 of the controller 100.

Referring to FIG. 5, the controller 100 acquires the state values of the target apparatus 50 (Step S100). That is, the controller 100 acquires information related to the consumption state of the product from the target that consumes the product. When the apparatus 50 is a washing machine, values, such as the remaining amounts of detergent, fabric softener, and bleach, are assumed as the state values of the apparatus 50.

The controller 100 determines whether or not the acquired status values of the apparatus 50 satisfy predetermined conditions (Step S102). That is, the controller 100 determines whether or not the predetermined conditions are satisfied on the basis of the acquired information.

When the acquired state values of the apparatus 50 do not satisfy the predetermined conditions (NO in Step S102), the subsequent process is skipped.

When the acquired state values of the apparatus 50 satisfy the predetermined conditions (YES in Step S102), the controller 100 generates the purchase request 12 according to the acquired status values of the apparatus 50 (Step S104) and transmits the generated purchase request 12 to the operation server 300 (Step S106). That is, when determining that the predetermined conditions are satisfied, the controller 100 generates the purchase request 12 for purchasing the product and transmits the purchase request 12 to the outside. Then, the process ends.

As described above, in the automated ordering function of the product trading system 1 according to this embodiment, the purchase request 12 for automatically purchasing a necessary product can be generated and transmitted according to the state of any target. That is, the controller 100 has a request generation function of generating the purchase request 12 for purchasing the product and transmitting the purchase request 12 to the outside (operation server 30) when determining that the predetermined conditions are satisfied on the basis of the acquired information (the state values of the target apparatus 50).

(c2: Acquisition of State Values)

Next, an example of a method for acquiring the state values will be described.

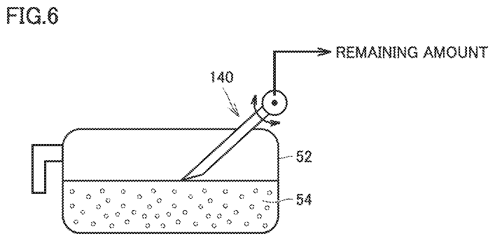

FIG. 6 is a schematic diagram illustrating an example of the configuration of the controller 100 of the product trading system 1 according to this embodiment for acquiring the state values. FIG. 6 illustrates a detergent tray 52 that is attached to the washing machine. The detergent tray 52 is filled with a detergent 54. The required amount of detergent is supplied to a washing tub whenever the washing machine performs washing.

The sensing unit 140 of the controller 100 is disposed in association with the detergent tray 52, and the rotation angle of the sensing unit 140 is changed depending on the amount of detergent 54 in the detergent tray 52. The sensing unit 140 outputs a signal indicating the remaining amount of detergent 54 in the detergent tray 52 according to the rotation angle. The remaining amount of detergent 54 in the detergent tray 52 is calculated on the basis of the output signal. The controller 100 determines whether or not predetermined conditions are satisfied on the basis of the calculated remaining amount of detergent 54.

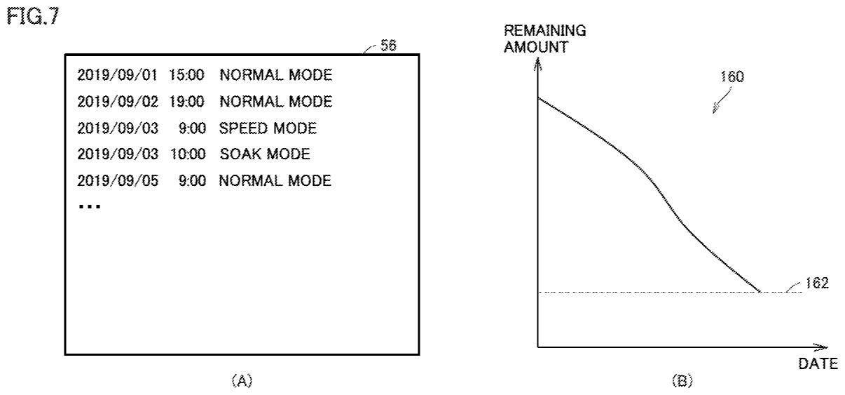

FIG. 7 is a schematic diagram illustrating another example of the configuration of the controller 100 of the product trading system 1 according to this embodiment for acquiring the state values. FIG. 7 illustrates an example in which the internal interface 130 of the controller 100 is connected to the apparatus 50.

FIG. 7(A) illustrates an example of history information 56 held by the apparatus 50 which is a washing machine. The controller 100 accesses the history information 56 or the like held by the apparatus 50 through the internal interface 130 and acquires a washing execution history of the apparatus 50. Then, the controller 100 calculates, for example, the amount of detergent consumed and the remaining amount of detergent on the basis of the acquired washing execution history.

FIG. 7(B) illustrates an example of an estimation result 160 of the remaining amount of detergent calculated by the controller 100. The controller 100 determines whether or not predetermined conditions are satisfied on the basis of the estimation result 160 illustrated in FIG. 7(B). For example, a predetermined threshold value 162 is set for the estimation result 160. When the remaining amount is less than the threshold value 162, the purchase request 12 may be generated. Alternatively, the time when the remaining amount is less than threshold value 162 may be predicted, and the purchase request 12 may be generated.

In addition, a method for acquiring the state values is not limited to the configurations illustrated in FIGS. 6 and 7, and any acquisition method corresponding to the target apparatus 50 and the target product can be adopted. Further, the user may be in charge of a portion or all of the process and configuration for acquiring the state values. For example, an aspect may be adopted in which the user visually checks the remaining amount and inputs the remaining amount obtained by the visual checking to the controller 100.

(c3: Conditions and Purchase Request)

Next, an example of the conditions related to the automated ordering function and the generated purchase request 12 will be described.

As illustrated in FIGS. 6 and 7, the controller 100 can acquire the remaining amount of detergent 54 in the target apparatus 50. Therefore, for example, the condition that the remaining amount is equal to or less than a predetermined lower limit is set in order to generate the purchase request 12. When this condition is satisfied, the controller 100 generates the purchase request 12.

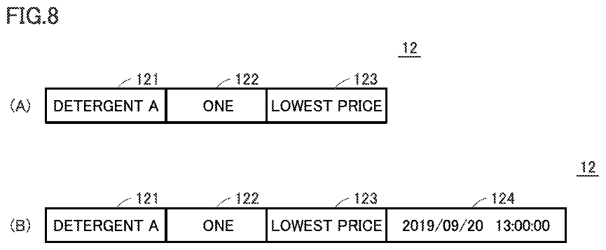

FIG. 8 is a schematic diagram illustrating an example of the purchase request 12 generated by the controller 100 of the product trading system 1 according to this embodiment.

Referring to FIG. 8(A), the purchase request 12 generated by the controller 100 (consumption entity 10) includes product information 121, number information 122, and a desired price 123.

Specification information (a product code which will be described below) for specifying the product to be purchased is stored in the product information 121.

The number information 122 is optional information, and information for specifying the number of products to be purchased is arbitrarily set in the number information 122. For example, when the number of products purchased is always one, the number information 122 may be omitted.

The desired price 123 is optional information and is arbitrarily set according to, for example, the characteristics of the product or the characteristics of the market. For example, instead of a specific desired purchase price, the “lowest price” or the like can be set in the desired price 123. In this case, a trade with the supplier 20 that offers the lowest price is established in the operation server 300 which will be described below.

As described above, the purchase request 12 includes the product information 121 which is an example of information for specifying the product desired to be purchased. In addition, the purchase request 12 may include at least one of the number of products desired to be purchased (number information 122) and the desired price (desired price 123) when the product is purchased.

In addition, in a case in which the estimation result 160 of the remaining amount of detergent illustrated in FIG. 7(B) can be used, it is possible to predict when the detergent will be used up. In this case, it is possible to roughly determine the deadline by which the product to be purchased is delivered to the target apparatus 50.

Therefore, as illustrated in FIG. 8(B), the purchase request 12 generated by the controller 100 (consumption entity 10) may further include a delivery deadline 124. In a case in which the delivery deadline 124 is included in the purchase request 12, the operation server 300 performs the matching process with the supplier 20 so as to meet the designated delivery deadline 124.

As described above, the purchase request 12 may include a delivery deadline (delivery deadline 124) that is determined on the basis of the acquired information.

FIG. 8 illustrates an example of the purchase request 12. However, the present disclosure is not limited thereto, and any data structure may be adopted.

In addition, the purchase request 12 illustrated in FIG. 8 may include information for specifying the consumption entity 10 (controller 100) which is a transmission source. Meanwhile, in a case in which secure data is exchanged between the controller 100 and the operation server 300, information for uniquely identifying the controller 100 may be provided to the operation server 300 in advance in a data exchange procedure. The adoption of this method makes it unnecessary to include information, which is preferred to be kept secret, in the purchase request 12 and makes it possible to reduce a security risk.

### D. SUPPLIER 20 AND SUPPLIER TERMINAL 200

Next, an example of a process of the supplier 20 (supplier terminal 200) of the product trading system 1 according to this embodiment will be described.

The supplier 20 operates the supplier terminal 200 to manage the inventory of the products to be provided to the consumption entities 10, generates the sales request 22, and transmits the sales request 22 to the operation server 300. That is, the supplier terminal 200 has a request generation function of generating the sales request 22 for selling the product and transmitting the sales request 22 to the outside (operation server 300).

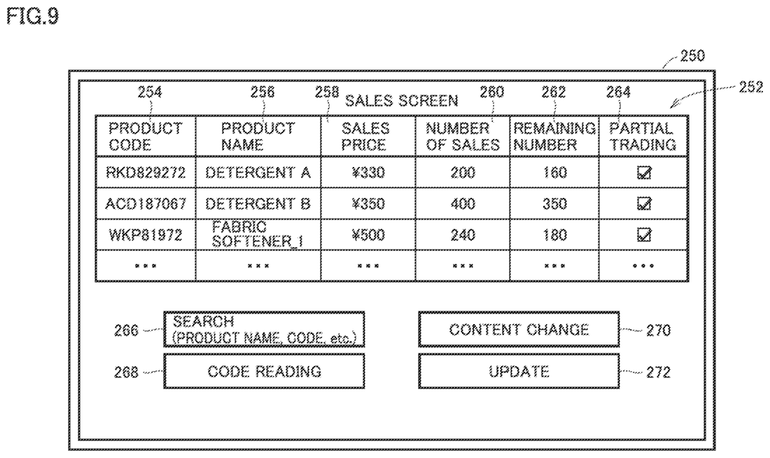

FIG. 9 is a schematic diagram illustrating an example of a user interface screen that is provided by the supplier terminal 200 of the product trading system 1 according to this embodiment. Referring to FIG. 9, a user interface screen 250 receives an instruction from the supplier 20 for generating the sales request 22.

Specifically, the user interface screen 250 includes a list 252 indicating a list of the products that can be sold by the supplier 20. The list 252 includes a product code field 254 indicating a product code for specifying each product that can be sold by the supplier 20, a product name field 256 indicating the name of each product, a sales price field 258 indicating the desired sales price of each product, a sales number field 260 indicating the desired number of products to be sold, a remaining number field 262 indicating the number of products for which trades have not yet been established among the desired number of products to be sold, and a partial trading field 264 that, in a case in which the content of a request is matched with only some of the products desired to be purchased, is used to set whether or not to process only the number of products matched with the content of the request as trade establishment.

The supplier 20 registers the products that can be sold in the list 252 and inputs the desired sales price (sales price field 258) and the desired sales number (sales number field 260) for each product.

The supplier 20 can select a search button 266, inputs, for example, a product name or a code for specifying the product to search for the products that can be sold, and registers the products in the list 252. Alternatively, the supplier 20 can select a code reading button 268 to read a bar code or a QR code (registered trademark) attached to the product desired to be purchased with a camera or the like mounted on the terminal, thereby registering the product, which can be sold, in the list 252.

The supplier 20 can select a content change button 270 to arbitrarily change the desired sales price (sales price field 258) and the desired sales number (sales number field 260) registered in the list 252. An update button 272 is selected to reflect the content changed by the supplier 20.

The supplier terminal 200 generates the sales request 22 through the user interface screen 250 illustrated in FIG. 6 and transmits the sales request 22 to the operation server 300.

In addition, the product handled in the product trading system 1 may be specified using identification information that is attached to, for example, a package. For example, product identification numbers, such as a Japanese Article Number (JAN) code, a European Article Number (EAN) code, GTIN-13, and GTIN-8, may be used as the identification information. The use of the product identification numbers makes it possible to facilitate the handling of the products that are distributed among a plurality of countries.

Furthermore, identification information for assembly packaging may be used. The identification information for assembly packaging includes product identification numbers that are set for assembly packaging (for example, cases, bowls, and pallets) which is the unit of trading between companies. A product code for assembly packaging, such as GTIN-14, is known as the identification information for assembly packaging. Since the product code for assembly packaging includes product identification numbers for individual products which are collectively packaged, the product transaction system 1 can handle the individual products and can handle a set of the individual products.

In addition, the product code for assembly packaging can be embodied as a bar code symbol such as an Inter-Leaved two of Five (ITF) symbol.

The use of both the identification information indicating individual products and the identification information for assembly packaging makes it possible to achieve more flexible trading according to the characteristics of the products and the circumstances of the supplier 20.

### E. OPERATION SERVER 300

Next, an example of a process in the operation server 300 of the product trading system 1 according to this embodiment will be described.

(e1: User Management)

The operation server 300 of the product trading system 1 manages user information required for the matching process.

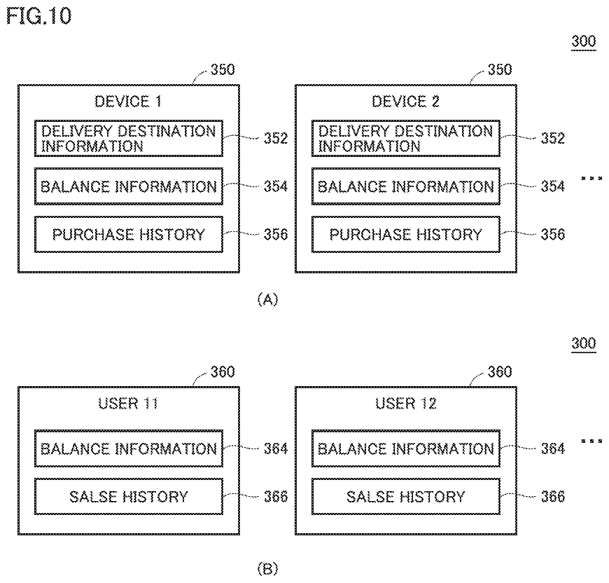

FIG. 10 is a diagram illustrating an example of the management of the user by the operation server 300 of the product trading system 1 according to this embodiment. FIG. 10(A) illustrates an example of management information 350 for managing each of the consumption entities 10, and FIG. 10(B) illustrates an example of management information 360 for managing each of the suppliers 20.

Referring to FIG. 10(A), the management information 350 for managing each of the consumption entities 10 includes delivery destination information 352 indicating a delivery destination (address or latitude/longitude) of the consumption entity 10. The delivery destination information 352 included in the management information 350 may be used as delivery destination information of the purchase request 12 received from the consumption entity 10. However, in a case in which the GPS 112 is mounted in the controller 100 of the consumption entity 10, the delivery destination information 352 may be omitted when the positional information of the controller 100 from the GPS 112 is included in the purchase request 12.

The management information 350 includes balance information 354 that indicates the account balance of the consumption entity 10. The balance information 354 embodies accounts that manage the economic values of each of the consumption entity 10 and the supplier 20. An amount of money in a specific currency is assumed as the economic value. However, the economic value may be an amount of money in a virtual currency or unique points used in the product trading system 1.

When the consumption entity 10 generates the purchase request 12, the operation server 300 reserves an estimated purchase amount of money determined on the basis of the purchase request 12 from the corresponding balance information 354. That is, the operation server 300 reserves a value determined according to the purchase request 12 from the account of the corresponding consumption entity 10.

The management information 350 includes a purchase history 356 indicating the trading information of the consumption entity 10. The operation server 300 updates the content of the purchase history 356 whenever a trade is established. In addition, the operation server 300 may reflect the content of the purchase request 12 in the balance information 354 whenever the consumption entity 10 generates the purchase request 12, in addition to whenever a trade is established.

Referring to FIG. 10(B), the management information 360 for managing each supplier 20 includes balance information 364 indicating the account balance of the supplier 20. When a trade is established between one of the consumption entities 10 and the supplier 20, the operation server 300 adds an amount of money exchanged by the trade to the corresponding balance information 364.

The management information 360 includes a sales history 366 indicating the trading information of the supplier 20. The operation server 300 updates the content of the sales history 366 whenever a trade is established.

As described above, the operation server 300 manages information related to the trade between the consumption entity 10 and the supplier 20 using the management information 350 and the management information 360 illustrated in FIG. 10.

(e2: Matching Process)

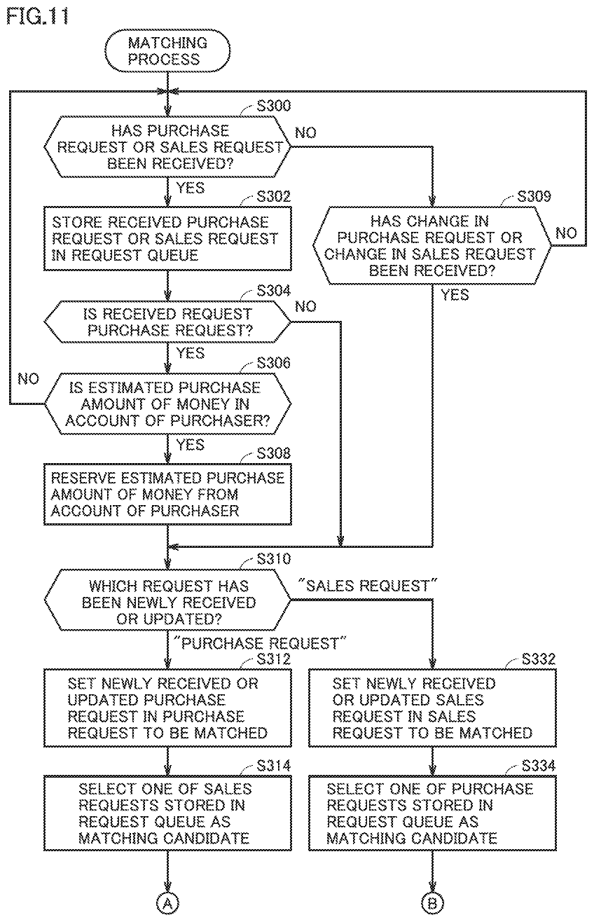

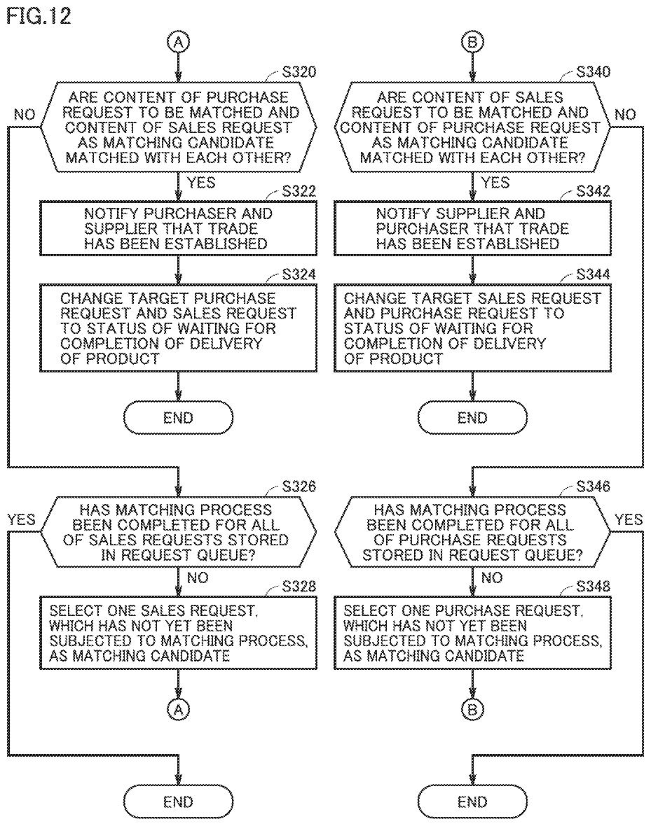

Next, an example of the matching process in the operation server 300 of the product trading system 1 will be described. FIGS. 11 and 12 are flowcharts illustrating the processing procedure of the matching process in the operation server 300 of the product trading system 1 according to this embodiment. FIGS. 11 and 12 illustrate a product trading method in which the trading of the product between the consumption entity 10 and the supplier 20 is performed by a computer.

Each step illustrated in FIGS. 11 and 12 is typically implemented by the execution of the matching program 312 and the payment program 314 (corresponding to the product trading program) by the processor 301 of the operation server 300.

Referring to FIG. 11 and FIG. 12, the operation server 300 determines whether the purchase request 12 from the controller 100 of the consumption entity 10 or the sales request 22 from the supplier terminal 200 of the supplier 20 has been received (Step S300). When the purchase request 12 from the controller 100 or the sales request 22 from the supplier terminal 200 has been received (YES in Step S300), the operation server 300 stores the received purchase request 12 or sales request 22 in the request queue 316. (Step S302).

Then, the operation server 300 determines whether or not the received request is the purchase request 12 (Step S304). When the received request is the purchase request 12 (YES in Step S304), the operation server 300 determines whether the estimated purchase amount of money determined on the basis of the content of the received purchase request 12 is in the account of the consumption entity 10 that has transmitted the purchase request 12 (Step S306).

When the estimated purchase amount of money is in the account of the consumption entity 10 (YES in Step S306), the operation server 300 reserves the estimated purchase amount of money from the account of the consumption entity 10 (Step S308). Then, the matching process after Step S310 is performed.

When the estimated purchase amount of money is not in the account of the consumption entity 10 (NO in Step S306), the operation server 300 does not perform the matching process after Step S310. At this time, the operation server 300 may notify the controller 100 of the consumption entity 10 that the purchase request 12 is not capable of being generated.

When the received request is the sales request 22 (NO in Step S304), the processes in Steps S306 and S108 are skipped.

When the purchase request 12 from the controller 100 of the consumption entity 10 or the sales request 22 from the supplier terminal 200 of the supplier 20 has not been received (NO in Step S300), the operation server 300 determines whether or not a change in the purchase request 12 from the controller 100 of the consumption entity 10 or a change in the sales request 22 from the supplier terminal 200 of the supplier 20 has been received (Step S309). When the change in the purchase request 12 from the controller 100 of the consumption entity 10 or the change in the sales requisition 22 from the supplier terminal 200 of the supplier 20 has been received (YES in Step S300), the matching process after Step S310 is performed.

When neither the change in the purchase request 12 from the controller 100 of the consumption entity 10 nor the change in the sales request 22 from the supplier terminal 200 of the supplier 20 has been received (NO in Step S300), the processes after Step S300 are repeated.

When the change in the purchase request 12 from the controller 100 of the consumption entity 10 and the change in the sales request 22 from the supplier terminal 200 of the supplier 20 have not been received (NO in Step S300), the processes after Step S300 are repeated.

The operation server 300 determines whether the newly received or updated request is the purchase request 12 or the sales request 22 (Step S310).

When the newly received or updated request is the purchase request 12 (“purchase request” in Step S310), the operation server 300 sets the newly received or updated purchase request 12 as the purchase request 12 to be matched (Step S312) and selects one of the sales requests 22 stored in the request queue 316 as a matching candidate (Step S314). Then, the operation server 300 compares the purchase request 12 to be matched with the sales request 22 which is the matching candidate and determines whether or not the contents of the requests are matched with each other (step S316).

When the content of the purchase request 12 to be matched is matched with the content of the sales request 22 which is the matching candidate (YES in Step S316), the operation server 300 determines that a trade has been established, notifies the consumption entity 10 and the supplier 20 respectively corresponding to the target purchase request 12 and sales request 22 that a trade has been established (Step S318), and changes the target purchase request 12 and sales request 22 to the status of waiting for the completion of delivery of the target product (Step S320). Then, the matching process ends.

When the content of the purchase request 12 to be matched is not matched with the content of the sales request 22 which is the matching candidate (NO in Step S316), the operation server 300 determines whether or not the matching process has been completed for all of the sales requests 22 stored in the request queue 316 (Step S322). When there is a sales request 22 that has not been subjected to the matching process among the sales requests 22 stored in the request queue 316 (NO in Step S322), the operation server 300 selects one sales request 22 that has not been subjected to the matching process as the matching candidate (Step S324) and repeats the processes after Step S316.

On the other hand, when the matching process has been completed for all of the sales requests 22 stored in the request queue 316 (YES in Step S322), the operation server 300 determines that the purchase request 12 and the sales request 22 whose contents are matched with each other have not been found and ends the matching process.

When the newly received or updated request is the sales request 22 (“sales request” in Step S310), the operation server 300 sets the newly received or updated sales request 22 as the sales request 22 to be matched (Step S332) and selects one of the purchase requests 12 stored in the request queue 316 as a matching candidate (Step S334). Then, the operation server 300 compares the sales request 22 to be matched with the purchase request 12 which is the matching candidate and determines whether or not the contents of the requests are matched with each other (Step S336).

When the content of the sales request 22 to be matched is matched with the content of the purchase request 12 which is the matching candidate (YES in Step S336), the operation server 300 determines that a trade has been established, notifies the supplier 20 and the consumption entity 10 respectively corresponding to the target sales request 22 and purchase requisition 12 that a trade has been established (Step S338), and changes the target sales request 22 and purchase request 12 to the status of waiting for the completion of delivery of the target product (Step S340). Then, the matching process ends.

When the content of the sales request 22 to be matched is not matched with the content of the purchase request 12 which is the matching candidate (NO in Step S336), the operation server 300 determines whether or not the matching process has been completed for all of the purchase requests 12 stored in the request queue 316 (Step S342). When there is a purchase request 12 that has not been subjected to the matching process among the purchase requests 12 stored in the request queue 316 (NO in Step S342), the operation server 300 selects one purchase request 12 that has not been subjected to the matching process as the matching candidate (Step S344) and repeats the processes after Step S336.

On the other hand, when the matching process has been completed for all of the purchase requests 12 stored in the request queue 316 (YES in Step S342), the operation server 300 determines that the sales request 22 and the purchase request 12 whose contents are matched with each other have not been found and ends the matching process.

### F. MODIFICATION EXAMPLES

In the above description, a typical example of the product trading system 1 according to this embodiment has been described. However, the following various modification examples can be applied. In addition, the modification examples described below can be appropriately applied in any combination.

(f1: EVER/IP (Registered Trademark))

EVER/IP (registered trademark) provided by Connect Free Co., Ltd. may be adopted as a communication protocol for each device constituting the product trading system 1 according to this embodiment. When EVER/IP is adopted, each device of the controller 100, the supplier terminal 200, and the operation server 300 has an authenticated IP address. That is, each device of the controller 100, the supplier terminal 200, and the operation server 300 has a network interface (communication unit) that performs data communication with a transmission destination using the authenticated IP address.

Here, the “authenticated IP address” means a state in which the validity of the IP address held by each device is guaranteed for a communication destination or a third party. In EVER/IP, the “authenticated IP address” means an IP address that is generated by an irreversible cryptographic hash function and has been authenticated directly or indirectly by a certificate authority. The use of the authenticated IP address makes it possible to guarantee that the IP address used by each device for data communication is not spoofed.

More specifically, the authenticated IP address is generated using a key pair of a private key and a public key held by each device and a predetermined hash function. A hash value is calculated by inputting the public key to a predetermined hash function, and all or some of the calculated hash values are the authenticated IP address of each device. The predetermined hash function is shared between the devices, which makes it possible to determine the IP address of another device, which is a transmission source of a public key, on the basis of the public key acquired from the device and to authenticate the validity of the IP address.

For example, the controller 100 performs data communication with the operation server 300, which is the transmission destination of the generated purchase request 12, using the authenticated IP address. In addition, the supplier terminal 200 performs data communication with the operation server 300, which is the transmission destination of the generated sales request 22, using the authenticated IP address. The use of the authenticated IP address makes it possible to authenticate the device that has transmitted the purchase request 12 and the sale request 22 and to prevent a fraudulent trade using, for example, spoofing.

(f2: Simplification of Matching Process)

In the above description, the matching process is given as an example assuming that the same product is provided by a plurality of suppliers 20. However, in a case in which there is only one supplier 20 that provides a specific product, the matching process may be simplified.

In this case, when the operation server 300 receives the purchase request 12 from the consumption entity 10 (controller 100), a trade may be established according to the content of the received purchase request 12.

In this case, a price predetermined between the consumption entity 10 and the supplier 20 may be adopted.

(f3: Delivery Charge)

In the matching process between the purchase request 12 and the sales request 22, a delivery charge may be considered. That is, the operation server 300 reflects a delivery charge for delivering a specific product from the supplier 20 to the consumption entity 10 and then determines whether or not the purchase request 12 and the sales request 22 are matched with each other. In the consideration of the delivery charge, a distance between the consumption entity 10 and the supplier 20 may be considered. An example of a method for calculating the delivery charge will be described below.

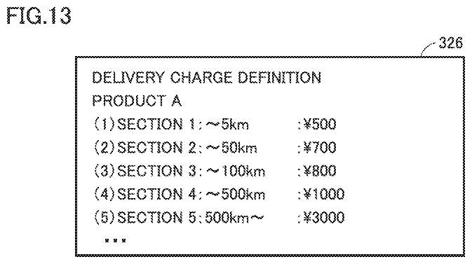

FIG. 13 is a diagram illustrating an example of delivery charge definition 326 used in the product trading system 1 according to this embodiment. The delivery charge definition 326 illustrated in FIG. 13 defines a delivery charge for each product (“product A” in the example of FIG. 13). In the delivery charge definition 326, the distance between the consumption entity 10 and the supplier 20 is divided (sections 1 to 5), and the delivery charge is defined for each section. When the calculation of the delivery charge is needed in the purchase request 12 or the sales request 22, the delivery charge is determined with reference to the delivery destination information 352 and the delivery charge definition 326 of the consumption entity 10.

The delivery charge definition 326 illustrated in FIG. 13 may be used as delivery charge definition for the sales request 22.

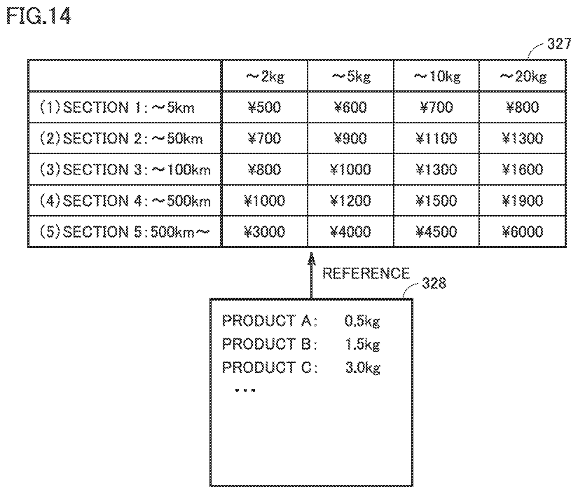

FIG. 14 is a diagram illustrating another example of delivery charge definition 327 used in the product trading system 1 according to this embodiment. The delivery charge definition 327 illustrated in FIG. 14 basically defines delivery charges for all products. In the delivery charge definition 327, the distance between the consumption entity 10 and the supplier 20 is divided (sections 1 to 5), and the delivery charge is defined for each section.

When it is necessary to calculate the delivery charge for any of the products, a weight for each product is determined with reference to a weight table 328 indicating a weight for each product, and the determined weight is added to the delivery charge definition 327 to determine the delivery charge.

In addition, FIGS. 13 and 14 illustrate an example in which the distance between the consumption entity 10 and the supplier 20 is divided and the delivery charge is defined for each section. However, the present disclosure is not limited thereto. A delivery charge per unit distance (for example, 1 km) may be defined. Further, delivery charge definitions for domestic and international use may be used.

As described above, in the product trading system 1 according to this embodiment, the above-mentioned delivery charge definition can be used to calculate a necessary delivery charge. The matching process may be performed in consideration of the delivery charge calculated in this way.

(f4: Usage Charge)

Either the consumption entity 10 or the supplier 20 may bear a charge for using the product trading system 1 according to this embodiment. For example, whenever the consumption entity 10 purchases a product, an amount of money obtained by multiplying the price of the product by a predetermined percentage (for example, 1.0%) may be automatically deducted as a usage charge from the account.

Alternatively, the supplier 20 that supplies the product may bear a usage charge corresponding to the number of products sold or a sales amount. In addition, the supplier 20 that supplies the product may bear a predetermined amount of money determined according to, for example, the number of products to be supplied as the usage charge. The bearing of the usage charge can be arbitrarily designed.

However, it is preferable to implement a process associated with the accounts of the consumption entity 10 and the supplier 20 such that the usage charge can be automatically calculated and collected.

(f5: Meta-Product)

In the product trading system 1 according to this embodiment, a plurality of products of the same type may be collectively handled as one product. This product is also called a “meta-product”.

For example, for a “detergent”, various products are provided. However, some of the consumption entities 10 simply want to purchase the “detergent” without specifying a specific producer and a specific product.

Therefore, for example, a meta-product that defines a comprehensive product type without specifying a product, such as “detergent AAA manufactured by company A”, may be defined.

Association information indicating which product is included in the meta-product is stored in the operation server 300, which makes it possible for the consumption entity 10 to order a “detergent” (regardless of the type of product).

On the other hand, the supplier 20 can provide any product as long as the product corresponds to the product type required by the meta-product. Therefore, it is possible to more easily perform, for example, inventory disposal.

In addition, the operation server 300 may manage which product is included in each meta-product, or conditions that can be included in each meta-product may be specified and the supplier 20 may sell the product as the meta-product according to the conditions. In a case in which the operation server 300 manages the meta-product, a table in which a product identification number indicating the meta-product is associated with a product identification number indicating each of one or more specific products included in the meta-product may be stored.

In this way, the meta-product can be used, which makes it possible to achieve more flexible product trading.

(f6: Expiration Date Option)

The consumption entity 10 and the supplier 20 may be configured to voluntarily cancel or withdraw the purchase request 12 and the sales request 22, respectively, until a trade is established. In addition, it may be necessary to purchase or sell the product by a specific deadline, depending on the characteristics of the product.

An expiration date may be set for the purchase request 12 and the sales request 22, considering the needs. More specifically, in a case in which the consumption entity 10 and the supplier 20 generate any purchase request 12 and any sales request 22, when a trade is not established, the deadline for canceling or withdrawing the request (the condition of the expiration date) may be added.

For the purchase request 12 or the sales request 22 with a designated expiration date, when a trade has not been established even though the designated expiration date comes, the operation server 300 forcibly cancels the corresponding purchase request 12 or sales request 22. The addition of the condition of the expiration date to the purchase request 12 or the sales request 22 makes it possible to avoid a situation in which a trade is established too late.

Any method, such as a method for designating a specific date, a specific date and time, today, this week, or this month, may be used as a method for designating the expiration date.

(f7: Option on Presence or Absence of Inventory)

In some cases, there is a situation in which the supplier 20 is scheduled to supply a specific product all the time, but is not able to supply the product for some reasons. In this case, the product is delivered to the consumption entity 10 as soon as it arrives. However, the supplier 20 waits until the product arrives.

Therefore, when the consumption entity 10 generates the purchase request 12, the presence or absence of the inventory of the designated product may be added as a condition. More specifically, a configuration may be used in which the consumption entity 10 can select whether to establish a trade only in a case in which the supplier 20 has a product in stock or even when the supplier 20 does not have a product in stock.

In a case in which the condition is that a trade is established only in a case in which the supplier 20 has a product in stock, a trade is established only in a case in which the supplier 20 has a specified product in stock.

On the other hand, in a case in which it is designated that a trade is established even when the supplier 20 does not have a product in stock, a configuration may be used in which the supplier 20 presents the consumption entity 10 with the time until a target product arrives.

(f8: Delivery Start Deadline Option)

In some cases, the consumption entity 10 wants to get a certain product as soon as possible. Therefore, when the consumption entity 10 generates the purchase request 12, a deadline for the delivery of a specified product from the supplier 20 may be added as a condition. More specifically, a configuration may be used in which the consumption entity 10 can designate the time from the establishment of a trade to the delivery of a product (for example, within 6 hours from the establishment of the trade) or a deadline for the delivery of the product (for example, October 1, 15:00 or the like).

In a case in which the purchase request 12 to which the condition has been added is generated, the operation server 300 receives information, such as delivery available time, from the supplier 20 and determines whether or not the content of the purchase request 12 is matched with the content of the sales request 22.

(f9: Delivery Available Range Option)

In some cases, the range in which a product can be delivered is limited depending on the business scale of the supplier 20. When the supplier 20 generates the sales request 22, the range in which the product can be delivered may be designated in advance, considering the limitation of the delivery range. More specifically, a configuration may be used in which the supplier 20 can designate the range in which the product can be delivered (for example, only in Japan and 500 km or not).

When the sales request 22 to which the condition has been added is generated, the operation server 300 determines whether or not the content of the purchase request 12 is matched with the content of the sales request 22 with reference to the delivery destination information of the consumption entity 10 (information indicating the position of the consumption entity 10).

### G. ANOTHER ASPECT OF PRODUCT TRADING SYSTEM 1

In the above description, the product trading system 1 centering on the operation server 300 is given as an example. However, a configuration without using the operation server 300 may be adopted. That is, a configuration similar to a kind of peer-to-peer configuration may be adopted.

(g1: System Initiated by Supplier 20)

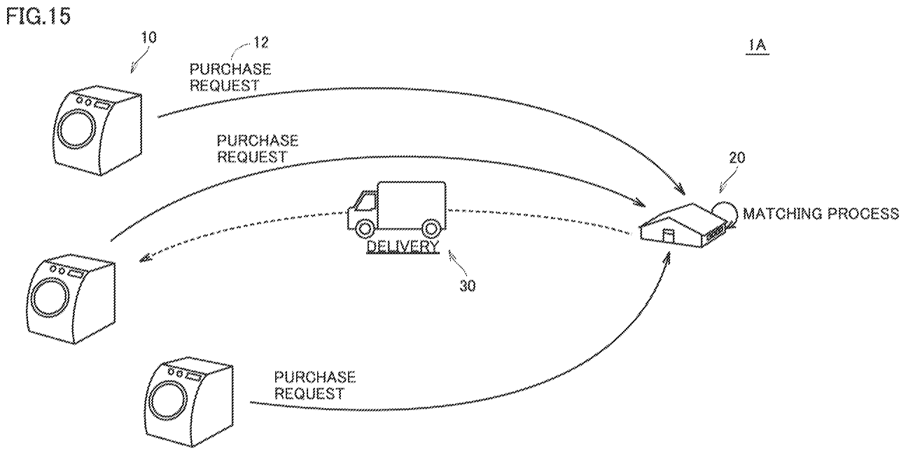

FIG. 15 is a diagram illustrating an overview of a process in another product trading system 1A according to this embodiment. Referring to FIG. 15, the product trading system 1A includes one or more consumption entities 10 and a supplier 20. In the product trading system 1A illustrated in FIG. 15, the operation server 300 is not provided, and the supplier 20 (supplier terminal 200) processes the purchase request 12 from the consumption entity 10 (controller 100).

That is, the supplier terminal 200 disposed in the supplier 20 performs the matching process. However, in the matching process performed by the supplier terminal 200, the content of the process is simplified since only a single supplier 20 generates the sales request 22.

As described above, the operation server 300 is not provided, and communication between the supplier 20 (supplier terminal 200) and one or more consumption entities 10 (controllers 100) may be performed to generate the purchase request 12 as needed.

In the product trading system 1A illustrated in FIG. 15, the supplier terminal 200 disposed in the supplier 20 may have the functions of the operation server 300 (for example, the matching program 312, the payment program 314, the request queue 316, the user information 318, and the like illustrated in FIG. 4), in addition to the configuration illustrated in FIG. 3.

(g2: System with Delivery Management Server 400)

In the product trading system 1A illustrated in FIG. 15, an example of the configuration using the supplier 20 (supplier terminal 200) having the same functions as the operation server 300 of the product trading system 1 illustrated in FIG. 1 is described. However, another server may be disposed for processes related to delivery.

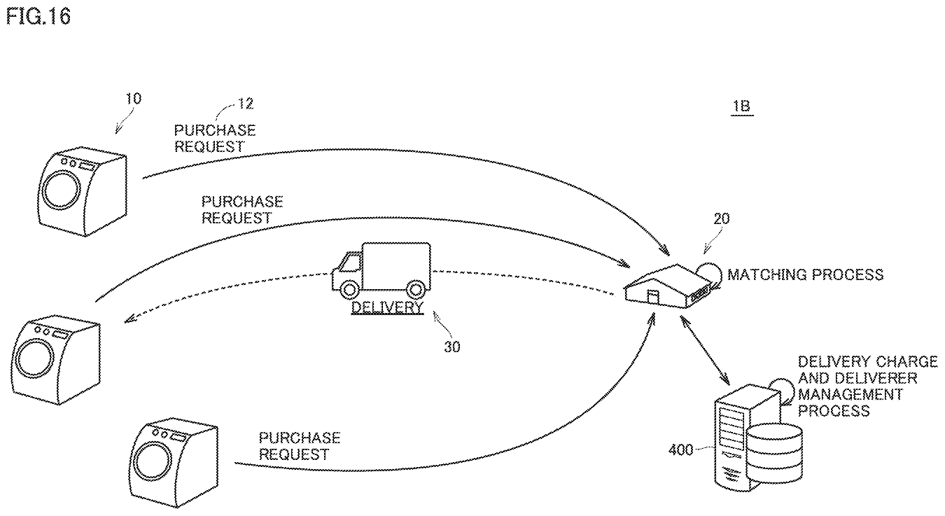

FIG. 16 is a diagram illustrating an overview of a process in yet another product trading system 1B according to this embodiment. Referring to FIG. 16, the product trading system 1B corresponds to a configuration obtained by adding a delivery management server 400 to the product trading system 1A illustrated in FIG. 15.

The delivery management server 400 performs a process of communicating with the supplier 20 (supplier terminal 200) to manage delivery charges and deliverers. That is, the delivery management server 400 has the delivery charge definitions 326 and 327 illustrated in FIGS. 13 and 14 and may perform, for example, a process of determining the delivery charges and a process of determining an appropriate deliverer from a plurality of deliverers.

As described above, the disposition of the delivery management server 400 in charge of the processes related to delivery makes it possible to collectively manage the requests from a plurality of suppliers 20 (supplier terminals 200) and to determine an appropriate deliverer 30. Therefore, it is possible to achieve efficient delivery. In addition, even when available deliverers are updated, only information held by the delivery management server 400 needs to be updated. Therefore, it is possible to achieve a flexible system.

### H. OTHER ASPECTS

(h1: Application Example of Automated Ordering Function)

The automated ordering function of the product trading system 1 according to this embodiment can be applied to various facilities and industries.

For example, the automated ordering function can be applied to a system that automatically orders hotel equipment (toothbrushes, towels, slippers, shampoos, toilet paper, and the like). In this case, the controller 100 may be connected to a reservation system of a hotel or the automated ordering program 108 (FIG. 2) may be incorporated in a portion of the reservation system of the hotel to acquire the total number of guests, and the required number of necessary amenities can be automatically ordered on the acquired information such as the total number of guests.

In addition, for example, the automated ordering function can be applied to a system that automatically orders necessary raw materials (milk, fruits, cups, straws, and the like) in a fresh juice shop. In this case, the controller 100 may be connected to a register or the automated ordering program 108 (FIG. 2) may be incorporated into a portion of the register to acquire, for example, the number and type of juices sold, and the required number of necessary raw materials may be automatically ordered on the basis of the acquired number and type of juices.

In this case, since the amounts of raw materials consumed differ for each type of juice, ingredient information, such as the types and amounts of raw materials consumed for each type of juice, is defined in advance, and the types and amounts of necessary raw materials can be determined by multiplying the defined ingredient information by the number of sales of each juice.

As described above, the product trading system 1 according to this embodiment can be applied to businesses in various fields.

(h2: Account)

In the product trading system 1, international product trading can also be performed. In this case, the account of the user may be standardized in a specific currency (for example, Japanese yen, US dollar, or the like), or the user may select a particular currency from a plurality of currencies. In a case in which a trade is performed between accounts in different currencies, payment may be performed between the accounts, considering an exchange rate at the time of trading.

Alternatively, any virtual currency may be used to manage the account of each user. When a common virtual currency is used, it is possible to omit a conversion process based on the exchange rate.

(h3: Distributed Disposition)

In the above description, an example in which the operation server 300 performs the matching process and the payment process has been described. However, each process may be implemented in different servers or may be implemented using a plurality of operation servers 300. For example, the operation server 300 may be prepared for each country or each region, and the operation servers 300 may cooperate with each other to achieve international product trading.

### I. ADVANTAGES

According to the product trading system 1 of this embodiment, the controller 100 acquires information related to the consumption state of a product from the target that consumes the product. When it is determined that a predetermined condition is satisfied on the basis of the acquired information, the controller 100 automatically generates the purchase request 12 for purchasing the product and transmits the purchase request 12 to, for example, the operation server 300. Then, product trading is performed through the operation server 300. Therefore, according to the product trading system 1 of this embodiment, it is possible to provide a platform that enables automated trading according to the situation.

The embodiment of the present disclosure needs be considered as an example and is not restrictive in all respects. The scope of the invention is indicated by the claims rather than the above description and is intended to include all changes within the scope and meaning equivalent to the claims.

### EXPLANATIONS OF LETTERS OR NUMERALS

1, 1A, 1B Product trading system

10 Consumption entity

12 Purchase request

20 Supplier

22 Sales request

30 Deliverer

50 Apparatus

52 Detergent tray

54 Detergent

56 History information

100 Controller

102, 201, 301 Processor

104 Main memory

106, 210, 310 Storage

108 Automated ordering program

110 Control unit

120, 203, 303 Network interface

121 Product information

122 Number information

123 Desired price

124 Delivery deadline

130 Internal interface

140 Sensing unit

150 Output unit

160 Estimation result

162 Threshold value

200 Supplier terminal

202, 302 Main memory

204, 304 Input unit

205, 305 Display

206, 306 Internal bus

212 Inventory management program

218 Inventory information

250 User interface screen

252 List

254 Product code field

256 Product name field

258 Sales price field

260 Sales number field

262 Remaining number field

264 Partial trading field

266 Search button

268 Code reading button

270 Content change button

272 Update button

300 Operation server

312 Matching program

314 Payment program

316 Request queue

318 User information

326, 327 Delivery charge definition

328 Weight table

350, 360 Management information

352 Delivery destination information

354, 364 Balance information

356 Purchase history

366 Sales history

400 Delivery management server

1. A controller comprising:
a state information acquisition unit that acquires information related to a consumption state of a product from a target consuming the product; and
a request generation unit that, when determining that a predetermined condition is satisfied based on the acquired information, generates a purchase request for purchasing the product and transmits the purchase request to an outside,
wherein the purchase request includes information specifying a product desired to be purchased.

2. The controller according to claim 1,
wherein the purchase request includes at least one of a plurality of the products desired to be purchased and a desired price when the product is purchased.

3. The controller according to claim 1,
wherein the purchase request includes a delivery deadline determined based on the acquired information.

4. The controller according to claim 1,
wherein the state information acquisition unit includes a sensing unit that senses a remaining amount of the product.

5. The controller according to claim 1,
wherein the state information acquisition unit includes an interface that acquires information managed by the target consuming the product.

6. The controller according to claim 1,
wherein the request generation unit attaches an electronic signature to the purchase request and transmits the purchase request to the outside.

7. The controller according to claim 1,
wherein the request generation unit has positional information of the controller in the purchase request and transmits the purchase request to the outside.

8. The controller according to claim 1, further comprising:
a communication unit that performs data communication with a transmission destination of the purchase request using an authenticated IP address.

9. A product trading system comprising:
a controller;
a sales request generation unit that generates a sales request for selling a product and transmits the sales request to an outside; and
a matching processing unit that determines a set of a purchase request and the sales request whose contents are matched with each other.

10. A non-transitory storage medium storing an automated ordering program thereon, the automated ordering program, when executed by one or more processors, causing the one or more processors to perform:
a step of acquiring information related to a consumption state of a product from a target consuming the product;
a step of determining whether a predetermined condition is satisfied based on the acquired information; and
a step of generating a purchase request for purchasing the product and transmitting the purchase request to an outside when a determination is made that the predetermined condition is satisfied,
wherein the purchase request includes information specifying a product desired to be purchased.

11. The non-transitory storage medium according to claim 10,
wherein the purchase request includes at least one of a plurality of the products desired to be purchased and a desired price when the product is purchased.

12. The non-transitory storage medium according to claim 10,
wherein the purchase request includes a delivery deadline determined based on the acquired information.

13. The non-transitory storage medium according to claim 10,
wherein the step of acquiring information comprises sensing a remaining amount of the product with a sensing unit.

14. The non-transitory storage medium according to claim 10,
wherein the step of acquiring information comprises acquiring information managed by the target consuming the product.

15. The non-transitory storage medium according to claim 10,
wherein the step of generating the purchase request comprises attaching an electronic signature to the purchase request and transmitting the purchase request to the outside.

16. The non-transitory storage medium according to claim 10,
wherein the step of generating the purchase request comprises adding positional information of the controller in the purchase request and transmitting the purchase request to the outside.

17. The non-transitory storage medium according to claim 10,
wherein the automated ordering program further causes the one or more processors to perform data communication with a transmission destination of the purchase request using an authenticated IP address.

18. The product trading system according to claim 9,
wherein the controller comprises:
a state information acquisition unit that acquires information related to a consumption state of a product from a target consuming the product; and
a request generation unit that, when determining that a predetermined condition is satisfied based on the acquired information, generates a purchase request for purchasing the product and transmits the purchase request to an outside.

19. The product trading system according to claim 18,
wherein the purchase request includes at least one of the number of products desired to be purchased and a desired price when the product is purchased.

20. The product trading system according to claim 18,
wherein the purchase request includes a delivery deadline determined based on the acquired information.
